(19) United States
(12) Patent Application Publication
(10) Pub. No.: US 2026/0292056 A1
(43) Pub. Date: Sep. 24, 2026

(54) SYSTEM AND METHOD FOR HANDLING UNWANTED CALLS AND MESSAGES

(71) Applicants: AT&T Intellectual Property I, L.P., Atlanta, GA (US); AT&T Mobility II LLC, Atlanta, GA (US)

(72) Inventors: Karen Stansbury, Snellville, GA (US); Howard L. Lang, Wayside, NJ (US); Derek Baylor, Mableton, GA (US); Antoine Diffloth, Sammamish, WA (US); Arthur Dileo, JR., Somerville, NJ (US); Mitchell Gunnels, Ball Ground, GA (US); Phillip Weeks, JR., Atlanta, GA (US)

(73) Assignees: AT&T Intellectual Property I, L.P., Atlanta, GA (US); AT&T Mobility II LLC, Atlanta, GA (US)

(21) Appl. No.: 19/082,611

(22) Filed: Mar. 18, 2025

(51) Int. Cl. H04M 3/22; H04M 1/72433; H04M 1/72436; H04M 1/72484; H04M 3/533

(52) U.S. Cl. CPC H04M 3/2281; H04M 1/72433; H04M 1/72436; H04M 1/72484; H04M 3/5335; H04M 2201/39; H04M 2201/405

(57) ABSTRACT

Aspects of the subject disclosure may include, for example, receiving, via an application programming interface, a communication content forwarded from a mobile device, wherein the communication content is selected from the group consisting of a voicemail message, an active call audio segment, and a text message, analyzing the communication content, wherein the analyzing comprises analyzing the communication content with artificial intelligence (AI) models and audio signal processing to determine an intent of the communication content and a probability that the communication content is AI generated, synthetic, or cloned, generating a threat indication based on the intent of the communication content and a probability that the communication content is AI generated, synthetic, or cloned, and transmitting the threat indication to the mobile device for display to a subscriber. Other embodiments are disclosed.

### FIELD OF THE DISCLOSURE

The subject disclosure relates to a system and method for detecting unwanted calls and messages.

### BACKGROUND

Nuisance calls and text messages may be used to commit fraud and scams against customers of communications networks. Frequently, highly targeted information is used in the attack. Most existing robocall detection services make decisions prior to answering a call and, as a result, do not have access to the text content or the audio characteristics of a potentially fraudulent communication.

### BRIEF DESCRIPTION OF THE DRAWINGS

Reference will now be made to the accompanying drawings, which are not necessarily drawn to scale, and wherein:

FIG. 1 is a block diagram illustrating an exemplary, non-limiting embodiment of a communications network in accordance with various aspects described herein.

FIG. 2A is a block diagram illustrating an example, non-limiting embodiment of a system functioning within the communication network of FIG. 1 in accordance with various aspects described herein.

FIG. 2B depicts an illustrative embodiment of a method in accordance with various aspects described herein.

FIG. 2C is a block diagram illustrating an example, non-limiting embodiment of a system functioning within the communication network of FIG. 1 in accordance with various aspects described herein.

FIG. 2D depicts an illustrative embodiment of a method in accordance with various aspects described herein.

FIG. 2E is a block diagram illustrating an example, non-limiting embodiment of a system functioning within the communication network of FIG. 1 in accordance with various aspects described herein.

FIG. 2F depicts an illustrative embodiment of a method in accordance with various aspects described herein.

FIG. 3 is a block diagram illustrating an example, non-limiting embodiment of a virtualized communication network in accordance with various aspects described herein.

FIG. 4 is a block diagram of an example, non-limiting embodiment of a computing environment in accordance with various aspects described herein.

FIG. 5 is a block diagram of an example, non-limiting embodiment of a mobile network platform in accordance with various aspects described herein.

FIG. 6 is a block diagram of an example, non-limiting embodiment of a communication device in accordance with various aspects described herein.

### DETAILED DESCRIPTION

The subject disclosure describes, among other things, illustrative embodiments for a system and method for detecting unwanted and AI-cloned communications in voicemail, live calls, and text messages by leveraging native OS functionality, existing network capabilities, and proprietary signals. A mobile device app and an analysis server are used to determine the intent of communications and identify synthetic or cloned voice characteristics, generating a threat level indicator for user awareness. This approach enhances user safety and trust without requiring costly network changes, while ensuring compliance with privacy regulations through user-initiated actions. Other embodiments are described in the subject disclosure.

One or more aspects of the subject disclosure include receiving a forwarded communication from a user device, wherein the forwarded communication is selected from an audio communication and a text communication, responsive to receiving the text communication as the forwarded communication, analyzing the text communication to determine an intent of the forwarded communication, responsive to receiving the text communication as the forwarded communication, determining whether the text communication contains artificial intelligence generation characteristics, and responsive to receiving the audio communication as the forwarded communication, analyzing audio features of the audio communication to determine if the voice is synthesized or human. The subject disclosure further discloses, responsive to receiving the audio communication as the forwarded communication, determining whether the audio communication includes synthetic or cloned voice characteristics, generating a threat level indicator based on the intent of the forwarded communication, a presence of artificial intelligence generation characteristics, and a presence of synthetic or cloned voice characteristics of the audio communication, and providing the threat level indicator to the user device.

One or more aspects of the subject disclosure include receiving, via an application programming interface, a communication content forwarded from a mobile device, wherein the communication content is selected from the group consisting of a voicemail message, an active call audio segment, and a text message, analyzing the communication content, wherein the analyzing comprises analyzing the communication content with artificial intelligence (AI) models and audio signal processing to determine an intent of the communication content and a probability that the communication content is AI generated, synthetic, or cloned, generating a threat indication based on the intent of the communication content and a probability that the communication content is AI generated, synthetic, or cloned, and transmitting the threat indication to the mobile device for display to a subscriber.

One or more aspects of the subject disclosure include receiving at a network server in a communications network, a forwarded communication from a user device active on the communication network, wherein the forwarded communication is selected from an audio communication and a text communication, analyzing the forwarded communication to determine an intent of the forwarded communication, wherein the analyzing, when applied to the text communication, comprises determining whether the text communication contains artificial intelligence generation characteristics, and wherein the analyzing, when applied to the audio communication, comprises both analyzing audio features to determine an intent of the audio communication and determining whether the audio communication includes synthetic voice characteristics or cloned voice characteristics, generating a threat level indicator based on the intent of the forwarded communication and a presence of the artificial intelligence generation characteristics or the synthetic voice characteristics or cloned voice characteristics, and providing the threat level indicator to the user device.

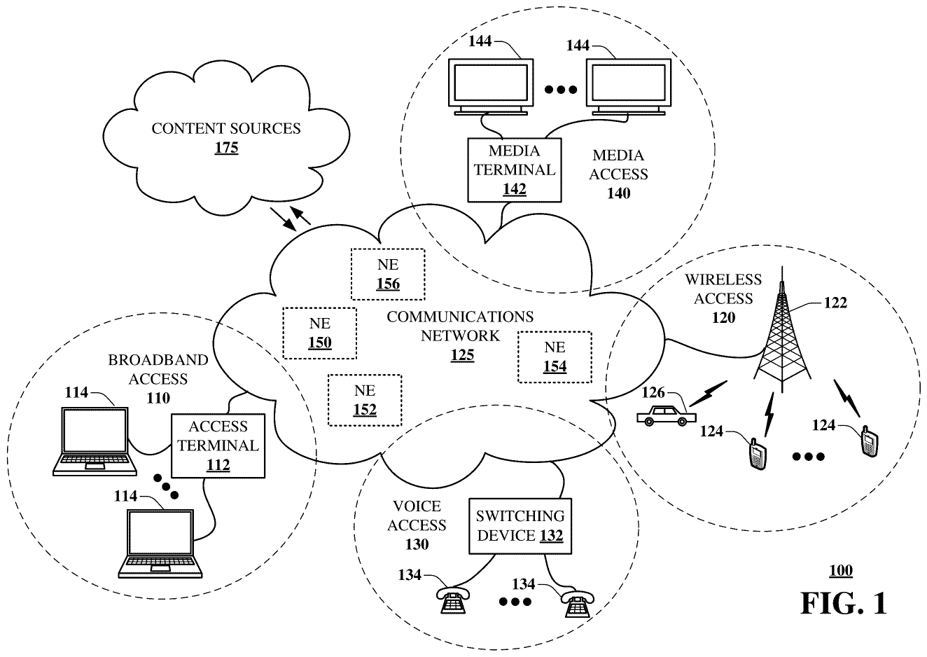

Referring now to FIG. 1, a block diagram is shown illustrating an example, non-limiting embodiment of a system 100 in accordance with various aspects described herein. For example, system 100 can facilitate in whole or in part determining the intent of communications including voicemail, live calls, and text messages and identifying synthetic or cloned voice characteristics, and generating a threat level indicator for user awareness. In particular, a communications network 125 is presented for providing broadband access 110 to a plurality of data terminals 114 via access terminal 112, wireless access 120 to a plurality of mobile devices 124 and vehicle 126 via base station or access point 122, voice access 130 to a plurality of telephony devices 134, via switching device 132 and/or media access 140 to a plurality of audio/video display devices 144 via media terminal 142. In addition, communication network 125 is coupled to one or more content sources 175 of audio, video, graphics, text and/or other media. While broadband access 110, wireless access 120, voice access 130 and media access 140 are shown separately, one or more of these forms of access can be combined to provide multiple access services to a single client device (e.g., mobile devices 124 can receive media content via media terminal 142, data terminal 114 can be provided voice access via switching device 132, and so on).

The communications network 125 includes a plurality of network elements (NE) 150, 152, 154, 156, etc. for facilitating the broadband access 110, wireless access 120, voice access 130, media access 140 and/or the distribution of content from content sources 175. The communications network 125 can include a circuit switched or packet switched network, a voice over Internet protocol (VoIP) network, Internet protocol (IP) network, a cable network, a passive or active optical network, a 4G, 5G, or higher generation wireless access network, WIMAX network, UltraWideband network, personal area network or other wireless access network, a broadcast satellite network and/or other communications network.

In various embodiments, the access terminal 112 can include a digital subscriber line access multiplexer (DSLAM), cable modem termination system (CMTS), optical line terminal (OLT) and/or other access terminal. The data terminals 114 can include personal computers, laptop computers, netbook computers, tablets or other computing devices along with digital subscriber line (DSL) modems, data over coax service interface specification (DOCSIS) modems or other cable modems, a wireless modem such as a 4G, 5G, or higher generation modem, an optical modem and/or other access devices.

In various embodiments, the base station or access point 122 can include a 4G, 5G, or higher generation base station, an access point that operates via an 802.11 standard such as 802.11n, 802.11ac or other wireless access terminal. The mobile devices 124 can include mobile phones, e-readers, tablets, phablets, wireless modems, and/or other mobile computing devices.

In various embodiments, the switching device 132 can include a private branch exchange or central office switch, a media services gateway, VoIP gateway or other gateway device and/or other switching device. The telephony devices 134 can include traditional telephones (with or without a terminal adapter), VoIP telephones and/or other telephony devices.

In various embodiments, the media terminal 142 can include a cable head-end or other TV head-end, a satellite receiver, gateway or other media terminal 142. The display devices 144 can include televisions with or without a set top box, personal computers and/or other display devices.

In various embodiments, the content sources 175 include broadcast television and radio sources, video on demand platforms and streaming video and audio services platforms, one or more content data networks, data servers, web servers and other content servers, and/or other sources of media.

In various embodiments, the communications network 125 can include wired, optical and/or wireless links and the network elements 150, 152, 154, 156, etc. can include service switching points, signal transfer points, service control points, network gateways, media distribution hubs, servers, firewalls, routers, edge devices, switches and other network nodes for routing and controlling communications traffic over wired, optical and wireless links as part of the Internet and other public networks as well as one or more private networks, for managing subscriber access, for billing and network management and for supporting other network functions.

The communications network 125 provides substantial convenience and reachability for subscribers. This is particularly true for wireless subscribers who may use a mobile device such as mobile device 124 for mobile access to the network. Callers and message-senders may readily contact a subscriber wherever the subscriber is located. However, for the subscriber who receives a random call or message, identifying the authenticity and safety of voice mail messages, text messages, and active calls poses a significant challenge for customers of a mobile network operator, such as the operator of the communications network 125.

Calls may include incoming voice calls, calls received and handled by voice mail of either the network or the mobile device, text messages such as electronic mail (email) messages, and short message service (SMS) messages provided by the communication network. Calls and messages may also include text, voice and video messaging provided by one or more applications or apps that enable instant text messaging, voice messaging, video messaging and voice calls. Such messages are generally transmitted over a network such as the public internet, with message termination at the network address of the mobile device of the customer. Such messages may be referred to as “over the top” or OTT messages.

Nuisance calls and text messages are often used to commit fraud and scams against customers of the mobile network operator. Frequently, highly targeted information of the customer is used in an attack directed at the customer or the customer's mobile device. Currently, some networks employ fraudulent call detection systems to identify robocalls or calls placed automatically and that use a computerized auto-dialer to deliver a pre-recorded message. Most of the existing robocall detection services make decisions “pre-answer,” or before the call is completed and the customer accepts the call. As a result, such conventional services do not have access to the text content or the audio characteristics of the communication.

A number of concerns are raised by such nuisance calls and text messages. For example, there is a risk of financial losses and identity theft by a user. The inability of the network or the user to identify a malicious intent of a communication can expose users to fraud and phishing attacks. In a phishing attack, attackers attempt to trick individuals into revealing sensitive information, such as passwords or other account credentials, credit card and bank account details, and personal identification information.

In another example, there may be a risk to a user's physical safety. Some scams may escalate into real-world scenarios that put customers in danger of physical harm. In another example, there may be a risk of raising trust issues. Uncertain authenticity undermines user confidence in engaging with these messages and calls. Through an over-abundance of caution, a customer may decide not to trust messages that are actually legitimate.

Another example pertains to legal regulatory compliance. This may include assuring that the solution to the problem of nuisance calls adheres to the latest rules of the United States Federal Communication Commission (FCC) and a patchwork of individual state regulations.

In accordance with various aspects described herein, a system and method enable more accurate determination of intent in order to identify unwanted fraud or scam calls. This may also include detection of synthetic voices and cloned voices. The system and method may be applied in a variety of scenarios. In some examples, voicemail messages may be analyzed to determine if they represent scam, fraud, or synthetic voice. In other examples, any time an active call is in progress, if the user or call recipient feels the call may be suspicious, the user can initiate the system and method to analyze the intent of the call and to determine whether the call includes a synthetic voice. In still other examples, content of text messages can be analyzed to determine a sender's intent and to determine if there may be a harmful threat such as scam or fraud. In embodiments, the system and method will have access to the plain text version of the message so the level of protection will even cover encrypted messages.

Advantageously, the disclosed system and method invention do not require costly network changes by the telecommunications carrier or mobile network operator. Conventional network signaling and mobile device features may be employed to provide the necessary functioning between a mobile device and a network server. Another advantage is simplified adherence to privacy regulations since the sharing of information is initiated by the user or subscriber. The system and method rely on native operating system (OS) functionality, existing network capabilities, proprietary network operator signals, a mobile device application (app) and generative AI in a new way to protect subscribers from scams, fraud and nuisance calls.

In embodiments, three communication paths are covered by solution, including voicemail threat detection, active call threat detection and text message threat detection. Thus, the solution is multi-modal in that it covers both audio and text-only communication. Moreover, in some embodiments, the protection may be extended to video call. Further, in some embodiments, information may be fed back to the pre-answer (voice) or pre-delivery (text) phase of message receipt and related to the intent of the message, and whether text or voice are synthesized, to help improve future decisions. Still further, aspects of the system and method may also consider user communities in the analysis, through the use of social graphing and other artificial intelligence techniques. Voice and message content that may be appropriate for one community may not be appropriate for another community, for example.

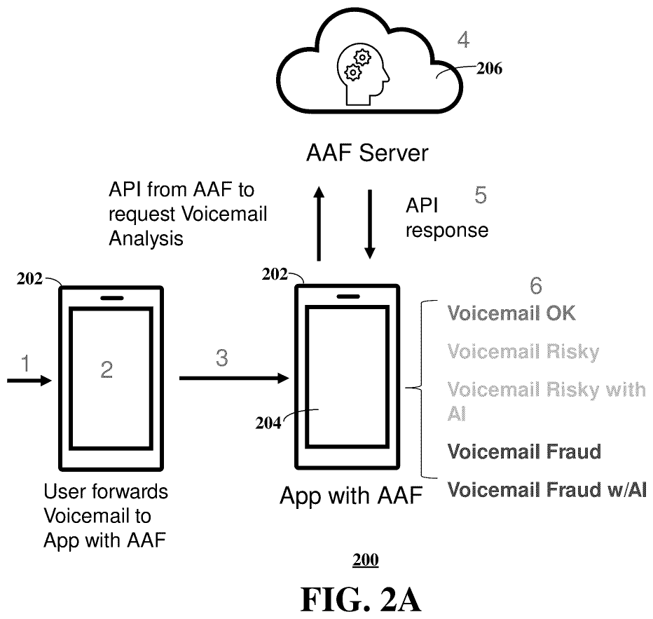

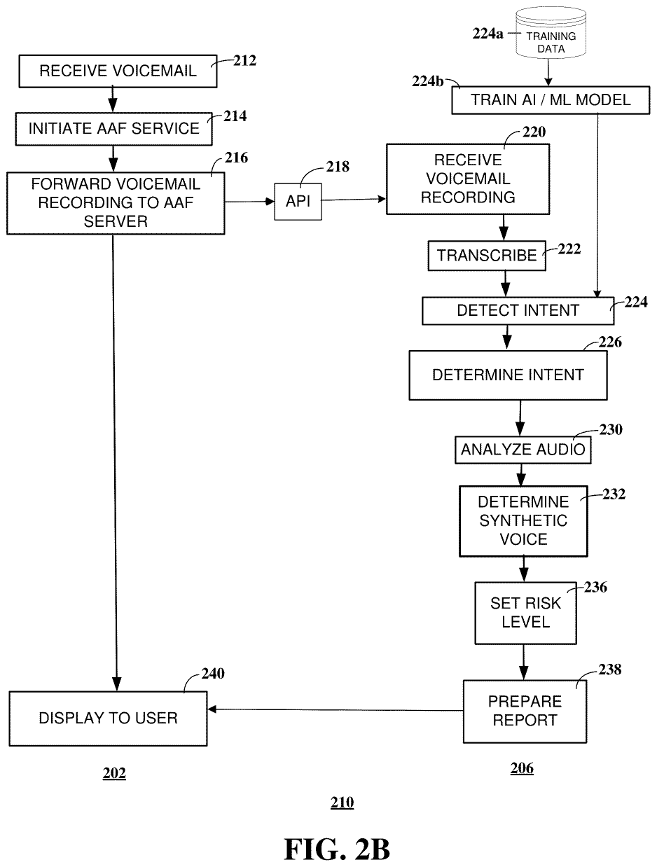

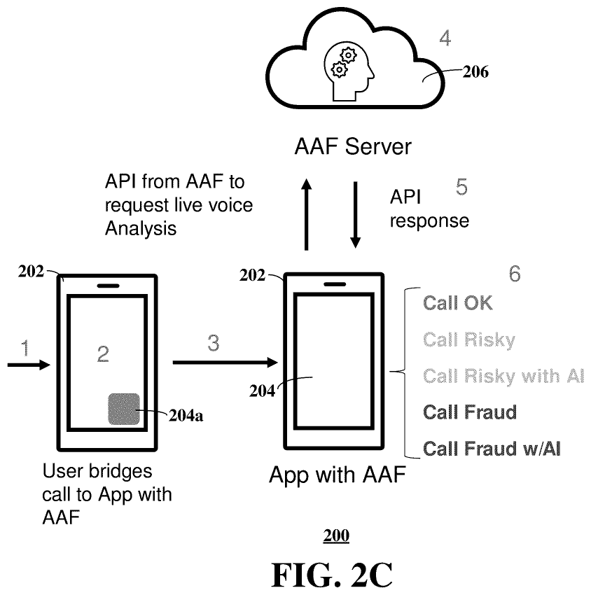

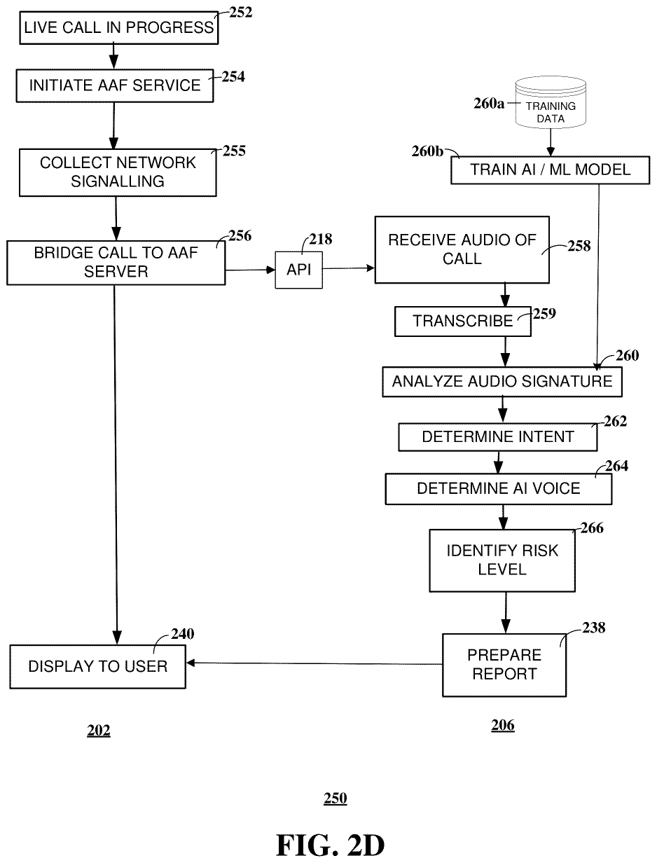

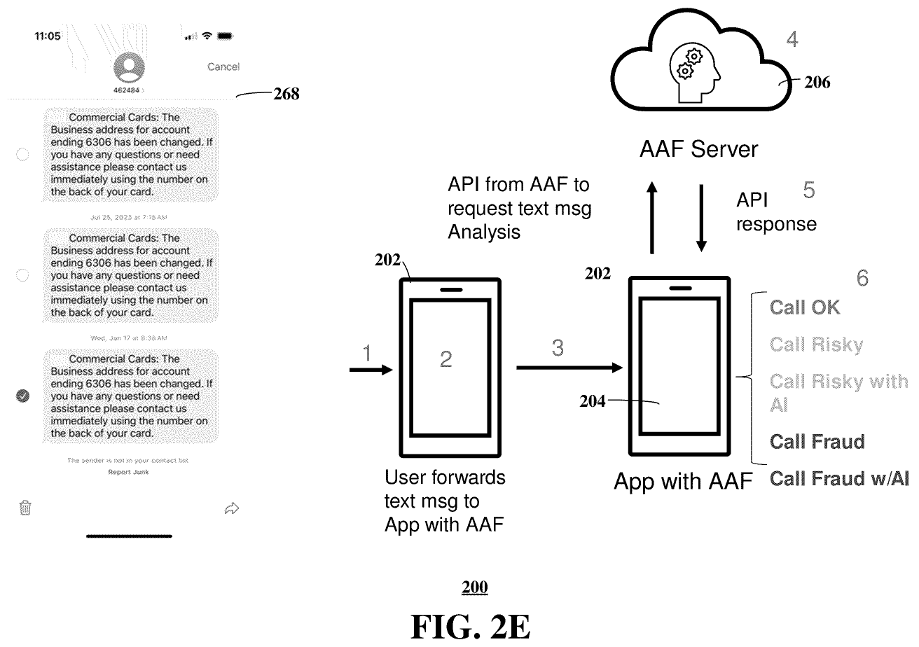

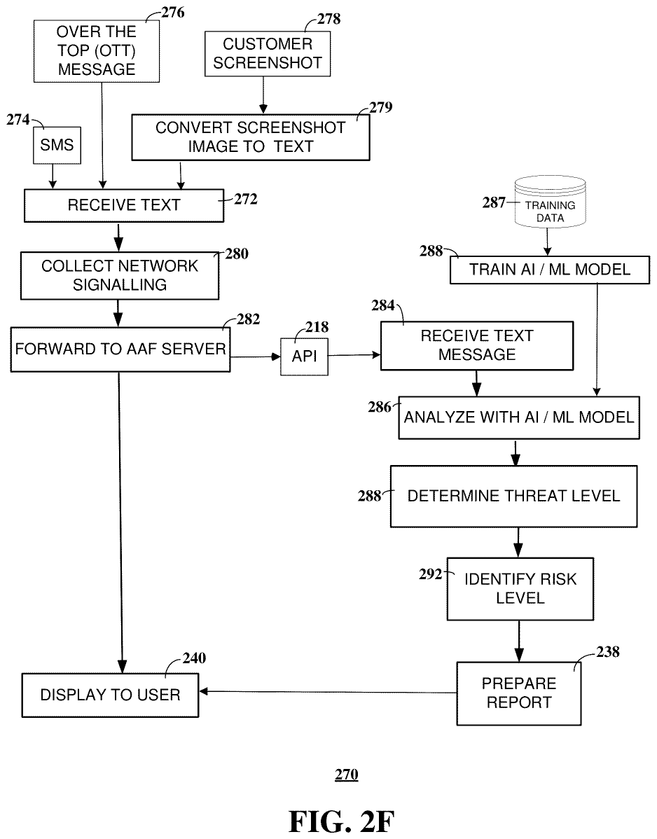

FIG. 2A is a block diagram illustrating an example, non-limiting embodiment of a system 200 functioning within the communication network 125 of FIG. 1 in accordance with various aspects described herein. The system 200 includes a mobile device 202 that interacts with a remote server over a network. In the example, the server may be termed the audio analysis feature (AAF) server 206. The mobile device 202 includes an application (app) which may be termed the AAF app 204. The AAF app 204 enables user interaction with features of the system and method for detecting unwanted voicemail, calls and messages directed to the mobile device 202. The system may also consider “user communities” in the analysis, through the use of social graphing and other AI Techniques. Voice and message content that may be appropriate for one community may not be appropriate for another community.

The mobile device 202 communicates with the AAF server 206 over one or more networks such as communications network 125. In particular, the mobile device 202 may be embodied as a mobile phone or user equipment (UE) which operates on a mobility network such as wireless access 120 (FIG. 1). Thus, the mobile device 202 may attach to a mobility network and communicate with the mobility network according to an air interface standard such as the fifth generation (5G) family of standards published by the 3rd Generation Partnership Project (3GPP). In other examples, the mobile device 202 may communicate using a local area network such as a Wi-Fi network according to any of the IEEE 802.xx family of specifications. The mobile device 202 may attach to a Wi-Fi hotspot for connection to, for example, the public internet.

The mobile device 202 may originate and receive voice calls, video calls, and text messages. Call setup and delivery, as well as message delivery, operates generally according to the 5G or other standards. The call may be answered and be completed, and the user or subscriber associated with the mobile device 202 may communicate with the calling party. If the user or subscriber is unavailable or declines the incoming call before it's answered, the call may be routed to a voicemail feature of the mobile device. In the voicemail feature, an outgoing message is played advising of the routing to voicemail and the calling party is given a chance to record a voicemail message. The user or subscriber may listen to the voicemail message at a later time. In the case of a text message, the mobility network may communicate a short messaging service (SMS) message or similar text message to the mobile device. The SMS message may include attachments such as data files. The user may access an application or feature of the mobile device 202 to view and respond to text messages including SMS messages.

In some examples, the mobile device 202 includes other communication applications which provide voice and text messaging capabilities. Such applications are referred to as “over the top” or OTT communications. Such communications bypass the established mobility network for delivery of voice and text messages. That is rather than communicating the voice and text messages through the infrastructure of the cellular network, the OTT communications use a data connection provided by the public internet for data communications. Thus, OTT communications rely on a data connection of the mobile device 202, whether the connection is Wi-Fi or cellular data such as 5G. Some OTT apps permit the mobile device 202 to send and receive text messages and voice messages and to make and receive voice and video call over the public internet.

FIG. 2A depicts an exemplary interaction between the mobile device 202 including AAF app 204, and AAF server 206. The mobile device 202 is equipped with the AAF app 204, which facilitates the forwarding of voicemail messages, text messages and audio from active voice and video calls to the AAF server 206 for analysis.

Voicemails are generally left by known callers for later attention by the user of the mobile device 202. However, in some instances, voicemails may be left for the victim by bad actors. This is indicated by the reference number 1 in FIG. 2A. If the voicemail is from an unknown or suspicious caller, the call recipient or user can choose to send the voicemail for analysis, using native mobile device functionality, prior to responding. The user initiates this process by initiating the AAF app 204, as indicated by reference number 2 in FIG. 2A.

The AAF app 204 may include any suitable interface for interaction by the user, including menus and commands displayed on a touch-sensitive display of the mobile device 202. The AAF app 204 may prompt the user to take action such as forwarding a received voicemail using the AAF app 204, as indicated by reference number 3 in FIG. 2A. The AAF app 204 then communicates with the AAF server 206 to request voicemail analysis, as shown by reference number 3. In embodiments, the AAF app 205 and the mobile device 202 communicate with the AAF server 206 via an application programming interface (API). Advantageously, the API acts as a clearly defined set of rules and protocols. The API specifies how the AAF app 204 can request information or services from the AAF server 206, and how the AAF server 206 should respond. The AAF app 204 may ensure that requests are formatted consistently, allowing the AAF server 206 to understand and process them efficiently. Further, the AAF API 204 allows control over what data and services of the AAF server 206 may be accessed by the AAF app 204.

The AAF server 206, as depicted in FIG. 2A, receives the forwarded voicemail and performs a series of analyses to determine the intent of the communication and whether it contains synthetic or cloned voice characteristics.

Based on the analysis, the AAF server 206 generates a threat level indicator, which is communicated back to the AAF app 204 on the mobile device 202, as indicated by reference number 5. The threat level indicator provides the user with information about the voicemail's risk level. Any suitable threat level indicator may be used or provided to the user. The threat level indicator may use a textual description, graphical images, or a combination of these. FIG. 2A illustrates an example of a multi-level threat level indicator in which the system 200 and the AAF app 204 advise the user that the received voice mail has a threat level such as “Voicemail OK,” “Voicemail Risky,” “Voicemail Risky with AI,” “Voicemail Fraud,” or “Voicemail Fraud w/AI,” as shown by reference number 6.

FIG. 2B depicts an illustrative embodiment of a method 210 in accordance with various aspects described herein. FIG. 2B provides a detailed flowchart of an exemplary embodiment of the method 210 for analyzing voicemail communications. This figure outlines the steps involved in detecting unwanted and AI-cloned voicemail communications using the mobile device 202, the AAF app 204, and the AAF server 206, for example.

Method 210 begins with step 212, where the mobile device 202 receives a voicemail. The user, suspecting potential fraud or AI-generated content, initiates the AAF service via the AAF app 204, as shown in step 214. This process ensures privacy compliance by allowing the subscriber to control the sharing of information. For example, generally if a communication with a user is being shared with a third party or recorded, permission or consent of the user must be obtained. In the illustrated example, such permission requirement is obviated. In examples, the user or the AAF app 204 may provide an audible notification to the calling party associated with the voicemail message that the voicemail message and its content may be shared with third parties.

In step 216, the voicemail recording is forwarded to the AAF server 206 using the AAF app 204. This makes use of a capability in mobile devices such as modern mobile phones to forward a voicemail to a designated service, which in this case is the AAF server 206. Any suitable preprocessing may be performed at the mobile device 202 or postprocessing at the AAF server 206. For example, the audio of the voicemail message may be encrypted or compressed for confidentiality or to reduce the amount of data to be transferred over the network. Further, any suitable signaling information associated with the voicemail message may be transferred to the AAF server 206. This may include metadata associated with the call that left the voicemail message such as calling part identification, called party identification, and other network addressing information. Such metadata and signaling information may be useful for determining the intent of the call and other aspects of a potential threat.

The call forwarding of step 216 is facilitated by an API 218, which establishes a communication link between the AAF app 204 and the AAF server 206. This step corresponds to the interaction depicted in FIG. 2A, where the AAF app 204 requests voicemail analysis from the AAF server 206.

Upon receiving the voicemail recording in step 220, the AAF server 206 transcribes the audio into text in step 222. This transcription may enable subsequent analysis, as it allows the server to apply natural language processing techniques to determine the intent of the communication. Any suitable transcription technique or technology may be used for step 222.

Step 224 involves detecting the intent of the voicemail. This analysis may include use of one or more AI/ML models. In embodiments, the AAF server 206 retrieves training data 224a to train one or more AI/ML models, step 224b, and thereby enhance the accuracy of the AI/ML models. Generally, the collection of training data 224a and training of models, step 224b, occurs in the background of the method 210 or offline. For example, the mobile network operator of the mobility network may receive a wide variety of text data including publicly available data sets and data collected internally. Further, the mobile network operator may set up one or more subscriber lines that are not connected to any live device or any customer device but merely operate to receive mistaken calls or fraudulent calls such as autodialed calls. Information provided to these subscriber lines becomes a source of training data for a system seeking to match and identify fraudulent calls and text messages. The data used for training may be supplemented with all the data collected and analyzed by the AAF service implemented on the AAF server 206 so that each subscriber who makes use of the AAF service contributes to training the models used at step 286.

In the example, step 226 determines if a malicious intent is associated with the voicemail message. In embodiments, natural language procedures may be used, along with generative artificial intelligence. One goal is to see if the intent behind the voicemail message is scam or fraud directed at the receiving party associated with the mobile device 202. Conventional intent analysis is performed pre answer, i.e., before the call is completed to a device such as the mobile device 202. If a malicious intent is detected, an alert or other notification may be generated in step 226.

If no malicious intent is found, the server proceeds to step 230, where it analyzes the audio features to determine if the voicemail contains synthetic or cloned voice characteristics. This analysis may use, for example, advanced AI models, which can identify synthetic voices with high confidence. In embodiments, the AAF server 206 analyzes the audio features of the voicemail message and determines a likelihood of synthetic or cloned voice. In embodiments, the server may use an ensemble of several types of models including generative artificial intelligence large-language models (GenAI LLMs), Siamese and convolutional neural networks as well as traditional natural language processing (NLP) techniques.

If synthetic voice characteristics are detected in step 232, another alert or notification may be generated. If not, the AAF server 206 sets a risk level in step 236, prepares a report in step 238. Any suitable reporting may be performed or provided. In embodiments, the step 236 establishes a likely risk level on a scale of possible risks, from “voicemail OK” to “voicemail fraud with AI,” as illustrated in FIG. 2A. Certainty as to intent and use of synthetic voice is unlikely, so a detected likelihood of threat level may be compared at step 236 with a threshold level. For example, if the AAF server 206 concludes the intent is more than 75% likely to be fraudulent, the alert may be generated. Any suitable threshold value, such as 50%, 75% or 90%, may be used. In some embodiments, the user may select the threshold using the user interface of the AAF app 204.

The report about the perceived or detected threat level is communicated from the AAF server 206 to the mobile device 202. The results displays may be displayed to the user via the AAF app 204 on the mobile device 202 in step 240. This comprehensive analysis and feedback loop thus illustrates generating a threat level indicator based on the intent and presence of AI characteristics.

FIG. 2C is a block diagram illustrating an example, non-limiting embodiment of the system 200 functioning within the communication network of FIG. 1 in accordance with various aspects described herein. FIG. 2C illustrates the system's operation for analyzing live calls, as described in conjunction with FIG. 2D. FIG. 2C highlights the interaction between the mobile device 202, the AAF app 204, and the AAF server 206, focusing on the detection of unwanted and AI-cloned communications during an active call.

In the example embodiment of FIG. 2C, the mobile device 202 is equipped with the AAF app 204, which allows the user to bridge an ongoing call to the AAF server 206 for analysis. For a live call in progress, a user or subscriber may be a potential victim of scam or fraud by bad actors. If the call is from an unknown or suspicious caller, while the call is in progress, the call recipient can choose to send the call to the audio analysis feature (AAF) analysis function to evaluate both intent of the call as well as whether the calling party is using AI cloned voice or other synthetic voice.

In some jurisdictions, the third party to a call that is to be recorded or processed needs to provide consent. In exemplary embodiments, the AAF app 204 or other source may announce its presence on the call when the AAF app 204 joins the call. The third party, the calling party, may choose to continue the call or hang up. The calling party may choose to continue the call or hang up. This alone may provide some protection for the user by alerting and scaring away the bad actor.

Following completion of the call, indicated by reference number 1, while the live call is in progress, the user or call recipient may become concerned about whether the calling party is engaged in a scam or fraud during the call. The user initiates this process by bridging the call to the AAF app 204, as indicated by reference number 2. This action is facilitated by the AAF app 204, which communicates with the AAF server 206 via an API to request live voice analysis, as shown by reference number 3.

In examples, the AAF app 204 provides a user interface for actuation by the user and for reporting information to the user about the AAF app 204. The user interface may employ a touch-sensitive display of the mobile device 202. In the example, during the call, the call recipient decides to take action to bridge the call to the AAF server 206. In the illustrated example, the user interface provides a shortcut on the device screen or a button press to initiate the bridge, such as icon 204a shown on the display of the mobile device 202. Responsive to actuation of the icon 204a or other device, the call audio is bridged to the AAF server 206 via three-way call.

In some embodiment a segment of the call audio from the live call is forwarded to the AAF server 206 for analysis. As indicated, in some embodiments, the ongoing audio of the live call is forwarded to the AAF server 206. The amount of audio transmitted from the mobile device 202 to the AAF server 206 may depend on a tradeoff. Generally, the more audio available for analysis at the AAF server 206, the better. More audio as an input can lead to a more reliable analysis and a more accurate conclusion about the intent of the call and presence of synthesized voice. On the other hand, conservation of network resources may require limiting the amount of call data collected and analyzed. The tradeoff between the two depends on factors including the traffic load at the AAF server 206 and how quickly an assessment may be made by the AAF server 206. Thus, if the AAF server 206 is not busy, it may be reasonable to monitor data during an hour-long call to draw a reliable conclusion about a fraudulent intent of presence of a synthetic voice. On the other hand, if the AAF process can reliably conclude the call is fraudulent after just a few seconds, the conclusion should be made and provided to the caller. Moreover, if the user is being actively subjected to the fraudulent call, it may be preferable to announce an appropriate alert and give the user the opportunity to terminate the call quickly.

In typical implementations, an embodiment of the system can conclude that a call likely uses a synthetic based on analysis of a 3 to 4 second segment of audio from the calling party. Determining the caller's intent can take longer and generally requires monitoring the conversation for a longer duration to discern the subject of the conversation and the intent of the caller.

The AAF server 206, depicted in FIG. 2C, receives the audio stream of the live call and performs a series of analyses to determine the intent of the communication and whether it includes synthetic or cloned voice characteristics. This process is further detailed in FIG. 2D.

Based on the analysis, the AAF server 206 generates a threat level indicator, which is communicated back to the AAF app 204 on the mobile device 202, as indicated by reference number 5. The threat level indicator provides the user with information about the call's risk level, such as “Call OK,” “Call Risky,” “Call Risky with AI,” “Call Fraud,” or “Call Fraud w/AI,” as shown by reference number 6. Different levels of risk may be identified, for example, based on an estimated percentage of likelihood of risk of an improper intent or percentage of likelihood of use of voice synthesis or voice cloning.

FIG. 2D depicts an illustrative embodiment of a method 250 in accordance with various aspects described herein. FIG. 2D provides a detailed flowchart of the method 250 for analyzing live call communications in conjunction with FIG. 2C. FIG. 2D outlines exemplary steps involved in detecting unwanted and AI-cloned communications using the mobile device 202, the AAF app 204, and the AAF server 206.

The process begins with step 252, where a live call is in progress on the mobile device 202. If the user suspects potential fraud or AI-generated content during the call, the user may initiate the AAF service via the AAF app 204, as shown in step 254. In the example, the user interface of the AAF app 204 includes an easily actuated icon 204a or link that may initiate the AAF service. Preferably, the icon is easy to locate and select because the user may be under some degree of stress during the active call. For example, if the call is fraudulent and the user is being instructed by the caller to do suspicious things or distracting things such as driving a motor vehicle, the user should be able to quickly and easily activate the AAF service directly from the mobile device 202 and to get a reasonably rapid response from the AAF service.

In step 254, in response to initiation of the AAF service via the AAF app 204 or otherwise, network signaling data is collected. Such network signaling data may include for example metadata associated with the text message. This data is then forwarded to the AAF server 206 using the AAF app 204, as indicated in step 256.

In step 256, the call is bridged to the AAF server 206 using the AAF app 204. This bridging is facilitated by an API 218, which establishes a communication link between the AAF app 204 and the AAF server 206. This step corresponds to the interaction depicted in FIG. 2C, where the AAF app 204 requests live voice analysis from the AAF server 206.

At step 258, the AAF server 206 receives audio of the call as well as the network signalling information collected at step 256. As indicated, any suitable amount of audio may be provided at step 258, from segments of just a few segments duration to the full audio of the call. The amount of audio provided may depend on a variety of factors such as available resources and a perceived need to respond rapidly. For example, the user initiating the AAF through the user interface of the AAF app 204 may have an option to select a faster response or a more reliable response, or to specify a desired confidence level such as 75% or 95%. Such user inputs may be used by the AAF server 206 during completion of the method 250.

Upon receiving the call audio in step 258, the AAF server 206 transcribes the audio into text in step 259. This transcription may enable subsequent analysis, as it allows the server to apply natural language processing techniques to determine the intent of the communication. Any suitable transcription technique or technology may be used for step 259.

The AAF server 206 analyzes the audio signature in step 260. This analysis may include the received audio, the transcription, or a combination of the two. This analysis may include use of one or more AI/ML models. In embodiments, the AAF server 206 retrieves training data 260a to train one or more AI/ML models, step 260b, and thereby enhance the accuracy of the AI/ML models. Generally, the collection of training data 260a and training of models, step 260b, occurs in the background of the method 250 or offline.

The analysis of step 260 determines the intent of the communication. Step 262 involves determining the intent of the call. In 262, for detecting the intent of the active call, natural language procedures may be used, along with generative artificial intelligence. (gen AI). One goal is to see if the intent behind the active call is to scam the call recipient or commit fraud directed at the receiving party associated with the mobile device 202.

Step 264 checks for AI voice characteristics, such as synthetic or cloned voices. Any suitable voice analysis techniques may be used. In embodiments, the AAF server 206 analyzes the audio features of the call audio received at step 258 to determine if the voice audio contains synthetic or cloned voice characteristics. This analysis may use, for example, advanced AI models, which can identify synthetic voices with high confidence. In embodiments, the AAF server 206 analyzes the audio features of the received call audio and determines a likelihood of synthetic or cloned voice. In embodiments, the server may use an ensemble of several types of models including generative artificial intelligence large-language models (GenAI LLMs), Siamese and convolutional neural networks as well as traditional natural language processing (NLP) techniques.

Based on the analysis, the AAF server 206 identifies the risk level in step 266 and prepares a report in step 238. Any suitable information and format may be used for reporting the result of the analysis to the user of the mobile device 202. The reporting may be an on-going process as the analysis of step 260, step 262 and step 264 continues with steaming audio received at the AAF server 206. The results of the reporting are then displayed to the user via the AAF app 204 on the mobile device 202 in step 240. As noted, any suitable reporting format may be used. For example, if the user requested expedited analysis during the ongoing call, the reporting may include vivid text or imagery displayed on the user interface of the mobile device 202 and an audio tone or other audio content such as a verbal warning played through a speaker or audio processing system of the mobile device. For example, in response to the reporting at step 238, the user interface of the AAF app 204 may announce to the speaker of the mobile device an alert such as, “Warning, this is determined to be a fraudulent call using synthesized voicing. This conclusion is considered to have 90% reliability based on analysis of the audio. Consider terminating the call promptly.” This comprehensive analysis and feedback loop thus enable generating a threat level indicator based on the intent and presence of AI characteristics.

Overall, FIG. 2D illustrates the methodical approach of the system in analyzing live call communications, leveraging the capabilities of the AAF app 204 and AAF server 206 to protect users from fraudulent and AI-generated content. The system's ability to provide real-time analysis and threat detection during live calls may be a substantial benefit to the user.

FIG. 2E is a block diagram illustrating an example, non-limiting embodiment of the system 200 functioning within the communication network of FIG. 1 in accordance with various aspects described herein. FIG. 2E illustrates operation of the system 200 for analyzing text message communications such as text string 268 illustrated in FIG. 2E, and in conjunction with FIG. 2F. FIG. 2 highlights the interaction between the mobile device 202, the AAF app 204, and the AAF server 206, focusing on the detection of unwanted and AI-generated content in text messages.

As illustrated herein, the mobile device 202 is equipped with the AAF app 204, which allows the user to forward a text message or text conversation or text string to the AAF server 206 for analysis. The user may initiate this process in any suitable manner such as by forwarding the text message such as text string 268 to the AAF app 204, as indicated by reference number 1. The AAF app 204 then communicates with the AAF server 206 via an API to request text message analysis, as shown by reference number 3.

The AAF server 206, depicted in FIG. 2E, receives the forwarded text message and performs a series of analyses to determine the intent of the text communication and whether the text communication contains AI-generated characteristics. This process is further detailed in FIG. 2F.

Based on the analysis, the AAF server 206 generates a threat level indicator, which is communicated back to the AAF app 204 on the mobile device 202, as indicated by reference number 5. The threat level indicator provides the user with information about the text message's risk level, such as “Message OK,” “Message Risky,” “Message Risky with AI,” “Message Fraud,” or “MessageFraud w/AI,” as shown by reference number 6.

Thus, the disclosed method and apparatus for performing these actions include using native OS functionality and proprietary network signals to detect unwanted communications without requiring costly network changes. The system provides an ability to analyze both audio and text communications, determine intent, and identify AI-generated content.

FIG. 2F depicts an illustrative embodiment of a method 270 in accordance with various aspects described herein. FIG. 2F provides an exemplary flowchart of the method 270 for analyzing text message communications such as text string 268 in conjunction with FIG. 2E. FIG. 2E outlines exemplary the steps involved in detecting unwanted and AI-generated content using the mobile device 202, the AAF app 204, and the AAF server 206.

The method 270 begins with step 272, where the mobile device 202 receives a text message. The user, suspecting potential fraud or AI-generated content, may forwards the text message to the AAF app 204. This forwarding is facilitated by native device functionality.

The mobile device 202 may receive the text message in a number for formats or from a number of sources. In one example, the text message is received as an SMS message using infrastructure and signaling of the mobility network, step 274. In a second example, the text message is received as an over the top or OTT message, step 276. OTT communications use a data connection provided by the public internet for data communications. Thus, OTT communications rely on a data connection of the mobile device 202, whether the connection is Wi-Fi or cellular data such as 5G. In an example, the OTT messaging is generally invisible to the mobility network. However, to activate the AAF service, the user or the AAF app 204 may copy and paste text from a received OTT message to another plain text message or into the AAF app 204 itself for forwarding to the AAF server 206.

In a third example, the text message is received as a screenshot, step 278. Some applications provide text messaging and voice and video calls, and some of these apps are highly conscious of security. Some apps may lock down the ability to forward messages outside of the app, such as to the AAF server 206. Similarly, some apps may encrypt the content of the text messages so that it cannot be read outside of the app, such as by the AAF server 206. Some app developers make it deliberately difficult to extract text from these messaging apps. However, the text of the text message is always decrypted for the user when the user is looking at the message within the app. Therefore, a user could readily take a screenshot as the text of the text message is displayed on the display screen of the mobile device 202, producing an image file. The image file may be stored in any suitable format in the mobile device 202, such as a jpeg-format file with a . jpg file extension. The user may then use conventional facilities of the mobile device 202 and the mobility network to send the image to a destination such as the AAF server 206. Moreover, the AAF app 204 may automatically send the image or perform text conversion. step 279, on the text in the image, then send the converted text to the AAF server 206.

In step 280, network signaling data is collected, which may include metadata associated with the text message. This data is then forwarded to the AAF server 206 using the AAF app 204, as indicated in step 282. This step corresponds to the interaction depicted in FIG. 2E, where the AAF app 204 requests text message analysis from the AAF server 206.

Upon receiving the text and associated data, the AAF server 206 analyzes the communication using AI/ML models in step 286. This analysis enables determining the intent of the communication and identifying AI-generated characteristics. The AAF server 206 retrieves training data 287 to train one or more AI/ML models and thereby enhance the accuracy of the AI/ML models. Generally, the collection of training data 287 and training of models occurs in the background of the method 270 or offline.

In addition, to help improve the accuracy of the risk scoring the analysis of step 286 may use all available data about the message sender including the data collected at step 280. Such data may include data from a short code database, 7726 reports, 800 number directory) to identify mismatches between senders and messages. Short codes are short numerical sequences, typically 5 or 6 digits, used for various communication services, primarily SMS and MMS messaging in a network. Short codes are designed to be easier to remember than standard 10-digit phone numbers. The short code database stores information that enables the network to correctly route messages sent to a short code to the appropriate destination. 7726 reports refer to a system for reporting unwanted or spam text messages and, in some cases, phone calls. The 800 number directory stores information about toll-free numbers available in the communications network 125.

Step 288 involves determining the threat level of the communication using one or more AI/ML models. Based on this analysis, the AAF server 206 identifies the risk level in step 292 and prepares a report in step 238. The results are then displayed to the user via the AAF app 204 on the mobile device 202 in step 240.

Overall, FIG. 2F illustrates the methodical approach of the system in analyzing text message communications, leveraging the capabilities of the AAF app 204 and AAF server 206 to protect users from fraudulent and AI-generated content, as outlined in the invention disclosure and supported by the inventor's insights. The system enables the ability to provide comprehensive analysis and threat detection for text messages.

While for purposes of simplicity of explanation, the respective processes are shown and described as a series of blocks in FIG. 2B, FIG. 2D, and FIG. 2F, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

Several alternate embodiments may be applied to the subject matter of the disclosure to enhance its functionality and adaptability. One exemplary embodiment is an integration with video communication, to extend the system to analyze video calls in addition to audio and text communications. This may involve analyzing video content for deepfake detection and assessing the intent of visual cues in conjunction with audio analysis.

Another embodiment involves developing a more interactive user interface within the AAF app 204 that provides real-time feedback and allows users to customize threat detection settings, such as adjusting sensitivity levels or selecting specific types of communications to analyze. Additionally, a community-based threat detection feature may be implemented, where users can report suspicious communications, and the system aggregates this data to improve threat detection accuracy. This may involve social graphing techniques to identify patterns across user communities. Multi-language support is also incorporated in some embodiments, using language-specific AI models and natural language processing techniques to ensure accurate intent detection across diverse user bases.

Furthermore, the system in some embodiments is designed to integrate with third-party security solutions or platforms, providing an additional layer of protection and enabling cross-platform threat intelligence sharing. Adaptive learning models are implemented to continuously update and refine their analysis based on new data and user feedback, improving the system's ability to detect emerging threats and AI-generated content. Privacy-enhanced features may be introduced, allowing users to anonymize certain aspects of their communications before analysis, ensuring compliance with stringent privacy regulations while still benefiting from threat detection.

Further, an offline analysis capability may be used, allowing the AAF app 204 to perform preliminary threat assessments without requiring an active network connection, providing users with immediate feedback even in low-connectivity environments. The system's functionality is also extended in some embodiments to include Internet of Things (IoT) devices, enabling threat detection for communications involving smart home devices, wearables, and other connected technologies. Further, in embodiments, users are allowed to customize the types and formats of alerts and notifications they receive, such as choosing between visual, auditory, or haptic feedback, and setting thresholds for different threat levels. These alternate embodiments enhance the versatility and effectiveness of the system, providing users with a more comprehensive and customizable solution for detecting unwanted and AI-generated communications.

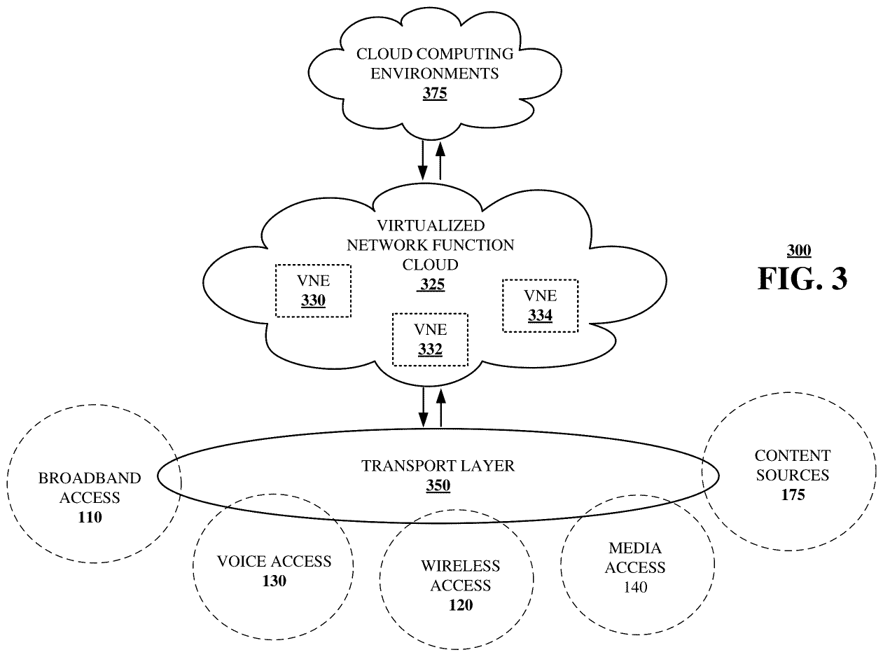

Referring now to FIG. 3, a block diagram is shown illustrating an example, non-limiting embodiment of a virtualized communication network 300 in accordance with various aspects described herein. In particular a virtualized communication network is presented that can be used to implement some or all of the subsystems and functions of system 100, the subsystems and functions of system 200, method 210, method 250 and method 270 presented in FIGS. 1, 2A, FIG. 2B, FIG. 2C, FIG. 2D, FIG. 2E, FIG. 2F and FIG. 3. For example, virtualized communication network 300 can facilitate in whole or in part determining the intent of communications including voicemail, live calls, and text messages and identifying synthetic or cloned voice characteristics, and generating a threat level indicator for user awareness.

In particular, a cloud networking architecture is shown that leverages cloud technologies and supports rapid innovation and scalability via a transport layer 350, a virtualized network function cloud 325 and/or one or more cloud computing environments 375. In various embodiments, this cloud networking architecture is an open architecture that leverages application programming interfaces (APIs); reduces complexity from services and operations; supports more nimble business models; and rapidly and seamlessly scales to meet evolving customer requirements including traffic growth, diversity of traffic types, and diversity of performance and reliability expectations.

In contrast to traditional network elements-which are typically integrated to perform a single function, the virtualized communication network employs virtual network elements (VNEs) 330, 332, 334, etc. that perform some or all of the functions of network elements 150, 152, 154, 156, etc. For example, the network architecture can provide a substrate of networking capability, often called Network Function Virtualization Infrastructure (NFVI) or simply infrastructure that is capable of being directed with software and Software Defined Networking (SDN) protocols to perform a broad variety of network functions and services. This infrastructure can include several types of substrates. The most typical type of substrate being servers that support Network Function Virtualization (NFV), followed by packet forwarding capabilities based on generic computing resources, with specialized network technologies brought to bear when general-purpose processors or general-purpose integrated circuit devices offered by merchants (referred to herein as merchant silicon) are not appropriate. In this case, communication services can be implemented as cloud-centric workloads.

As an example, a traditional network element 150 (shown in FIG. 1), such as an edge router can be implemented via a VNE 330 composed of NFV software modules, merchant silicon, and associated controllers. The software can be written so that increasing workload consumes incremental resources from a common resource pool, and moreover so that it is elastic: so, the resources are only consumed when needed. In a similar fashion, other network elements such as other routers, switches, edge caches, and middle boxes are instantiated from the common resource pool. Such sharing of infrastructure across a broad set of uses makes planning and growing infrastructure easier to manage.

In an embodiment, the transport layer 350 includes fiber, cable, wired and/or wireless transport elements, network elements and interfaces to provide broadband access 110, wireless access 120, voice access 130, media access 140 and/or access to content sources 175 for distribution of content to any or all of the access technologies. In particular, in some cases a network element needs to be positioned at a specific place, and this allows for less sharing of common infrastructure. Other times, the network elements have specific physical layer adapters that cannot be abstracted or virtualized and might require special DSP code and analog front ends (AFEs) that do not lend themselves to implementation as VNEs 330, 332 or 334. These network elements can be included in transport layer 350.

The virtualized network function cloud 325 interfaces with the transport layer 350 to provide the VNEs 330, 332, 334, etc. to provide specific NFVs. In particular, the virtualized network function cloud 325 leverages cloud operations, applications, and architectures to support networking workloads. The virtualized network elements 330, 332 and 334 can employ network function software that provides either a one-for-one mapping of traditional network element function or alternately some combination of network functions designed for cloud computing. For example, VNEs 330, 332 and 334 can include route reflectors, domain name system (DNS) servers, and dynamic host configuration protocol (DHCP) servers, system architecture evolution (SAE) and/or mobility management entity (MME) gateways, broadband network gateways, IP edge routers for IP-VPN, Ethernet and other services, load balancers, distributers and other network elements. Because these elements do not typically need to forward large amounts of traffic, their workload can be distributed across a number of servers-each of which adds a portion of the capability, and which creates an elastic function with higher availability overall than its former monolithic version. These virtual network elements 330, 332, 334, etc. can be instantiated and managed using an orchestration approach similar to those used in cloud compute services.

The cloud computing environments 375 can interface with the virtualized network function cloud 325 via APIs that expose functional capabilities of the VNEs 330, 332, 334, etc. to provide the flexible and expanded capabilities to the virtualized network function cloud 325. In particular, network workloads may have applications distributed across the virtualized network function cloud 325 and cloud computing environment 375 and in the commercial cloud or might simply orchestrate workloads supported entirely in NFV infrastructure from these third-party locations.

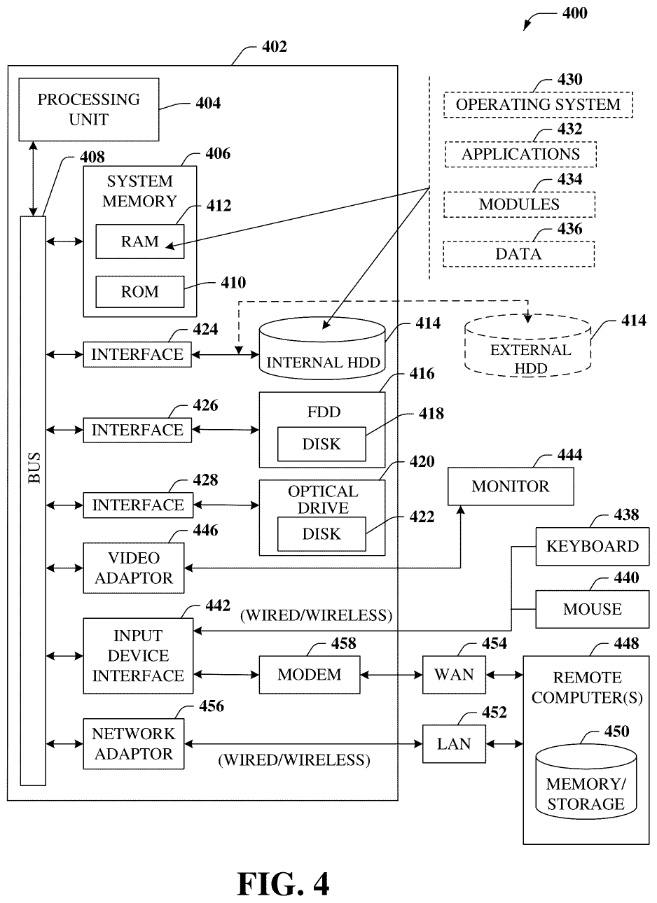

Turning now to FIG. 4, there is illustrated a block diagram of a computing environment in accordance with various aspects described herein. In order to provide additional context for various embodiments of the embodiments described herein, FIG. 4 and the following discussion are intended to provide a brief, general description of a suitable computing environment 400 in which the various embodiments of the subject disclosure can be implemented. In particular, computing environment 400 can be used in the implementation of network elements 150, 152, 154, 156, access terminal 112, base station or access point 122, switching device 132, media terminal 142, and/or VNEs 330, 332, 334, etc. Each of these devices can be implemented via computer-executable instructions that can run on one or more computers, and/or in combination with other program modules and/or as a combination of hardware and software. For example, computing environment 400 can facilitate in whole or in part determining the intent of communications including voicemail, live calls, and text messages and identifying synthetic or cloned voice characteristics, and generating a threat level indicator for user awareness.

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM), flash memory or other memory technology, compact disk read only memory (CD-ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 4, the example environment can comprise a computer 402, the computer 402 comprising a processing unit 404, a system memory 406 and a system bus 408. The system bus 408 couples system components including, but not limited to, the system memory 406 to the processing unit 404. The processing unit 404 can be any of various commercially available processors. Dual microprocessors and other multiprocessor architectures can also be employed as the processing unit 404.

The system bus 408 can be any of several types of bus structure that can further interconnect to a memory bus (with or without a memory controller), a peripheral bus, and a local bus using any of a variety of commercially available bus architectures. The system memory 406 comprises ROM 410 and RAM 412. A basic input/output system (BIOS) can be stored in a non-volatile memory such as ROM, erasable programmable read only memory (EPROM), EEPROM, which BIOS contains the basic routines that help to transfer information between elements within the computer 402, such as during startup. The RAM 412 can also comprise a high-speed RAM such as static RAM for caching data.

The computer 402 further comprises an internal hard disk drive (HDD) 414 (e.g., EIDE, SATA), which internal HDD 414 can also be configured for external use in a suitable chassis (not shown), a magnetic floppy disk drive (FDD) 416, (e.g., to read from or write to a removable diskette 418) and an optical disk drive 420, (e.g., reading a CD-ROM disk 422 or, to read from or write to other high-capacity optical media such as the DVD). The HDD 414, magnetic FDD 416 and optical disk drive 420 can be connected to the system bus 408 by a hard disk drive interface 424, a magnetic disk drive interface 426 and an optical drive interface 428, respectively. The hard disk drive interface 424 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 402, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 412, comprising an operating system 430, one or more application programs 432, other program modules 434 and program data 436. All or portions of the operating system, applications, modules, and/or data can also be cached in the RAM 412. The systems and methods described herein can be implemented utilizing various commercially available operating systems or combinations of operating systems.

A user can enter commands and information into the computer 402 through one or more wired/wireless input devices, e.g., a keyboard 438 and a pointing device, such as a mouse 440. Other input devices (not shown) can comprise a microphone, an infrared (IR) remote control, a joystick, a game pad, a stylus pen, touch screen or the like. These and other input devices are often connected to the processing unit 404 through an input device interface 442 that can be coupled to the system bus 408, but can be connected by other interfaces, such as a parallel port, an IEEE 1394 serial port, a game port, a universal serial bus (USB) port, an IR interface, etc.

A monitor 444 or other type of display device can be also connected to the system bus 408 via an interface, such as a video adapter 446. It will also be appreciated that in alternative embodiments, a monitor 444 can also be any display device (e.g., another computer having a display, a smart phone, a tablet computer, etc.) for receiving display information associated with computer 402 via any communication means, including via the Internet and cloud-based networks. In addition to the monitor 444, a computer typically comprises other peripheral output devices (not shown), such as speakers, printers, etc.

The computer 402 can operate in a networked environment using logical connections via wired and/or wireless communications to one or more remote computers, such as a remote computer(s) 448. The remote computer(s) 448 can be a workstation, a server computer, a router, a personal computer, portable computer, microprocessor-based entertainment appliance, a peer device or other common network node, and typically comprises many or all of the elements described relative to the computer 402, although, for purposes of brevity, only a remote memory/storage device 450 is illustrated. The logical connections depicted comprise wired/wireless connectivity to a local area network (LAN) 452 and/or larger networks, e.g., a wide area network (WAN) 454. Such LAN and WAN networking environments are commonplace in offices and companies, and facilitate enterprise-wide computer networks, such as intranets, all of which can connect to a global communications network, e.g., the Internet.

When used in a LAN networking environment, the computer 402 can be connected to the LAN 452 through a wired and/or wireless communication network interface or adapter 456. The adapter 456 can facilitate wired or wireless communication to the LAN 452, which can also comprise a wireless AP disposed thereon for communicating with the adapter 456.

When used in a WAN networking environment, the computer 402 can comprise a modem 458 or can be connected to a communications server on the WAN 454 or has other means for establishing communications over the WAN 454, such as by way of the Internet. The modem 458, which can be internal or external and a wired or wireless device, can be connected to the system bus 408 via the input device interface 442. In a networked environment, program modules depicted relative to the computer 402 or portions thereof, can be stored in the remote memory/storage device 450. It will be appreciated that the network connections shown are example and other means of establishing a communications link between the computers can be used.

The computer 402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10BaseT wired Ethernet networks used in many offices.

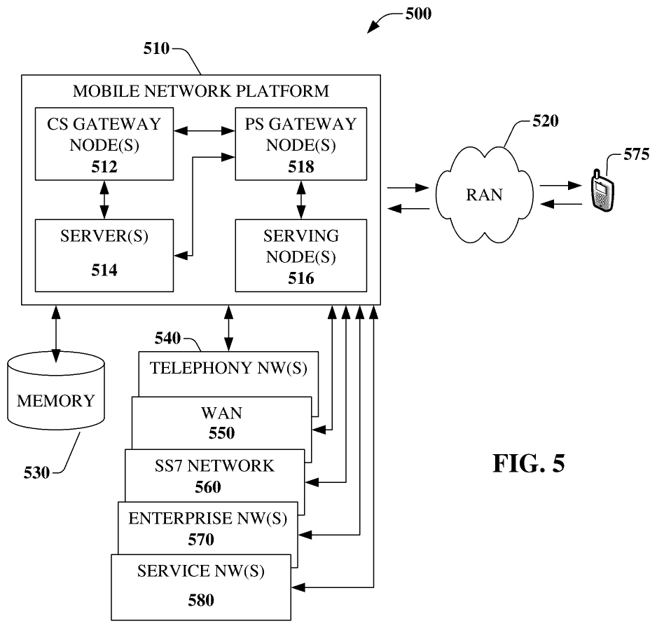

Turning now to FIG. 5, an embodiment 500 of a mobile network platform 510 is shown that is an example of network elements 150, 152, 154, 156, and/or VNEs 330, 332, 334, etc. For example, platform 510 can facilitate in whole or in part determining the intent of communications including voicemail, live calls, and text messages and identifying synthetic or cloned voice characteristics, and generating a threat level indicator for user awareness. In one or more embodiments, the mobile network platform 510 can generate and receive signals transmitted and received by base stations or access points such as base station or access point 122. Generally, mobile network platform 510 can comprise components, e.g., nodes, gateways, interfaces, servers, or disparate platforms, that facilitate both packet-switched (PS) (e.g., internet protocol (IP), frame relay, asynchronous transfer mode (ATM)) and circuit-switched (CS) traffic (e.g., voice and data), as well as control generation for networked wireless telecommunication. As a non-limiting example, mobile network platform 510 can be included in telecommunications carrier networks and can be considered carrier-side components as discussed elsewhere herein. Mobile network platform 510 comprises CS gateway node(s) 512 which can interface CS traffic received from legacy networks like telephony network(s) 540 (e.g., public switched telephone network (PSTN), or public land mobile network (PLMN)) or a signaling system #7 (SS7) network 560. CS gateway node(s) 512 can authorize and authenticate traffic (e.g., voice) arising from such networks. Additionally, CS gateway node(s) 512 can access mobility, or roaming, data generated through SS7 network 560; for instance, mobility data stored in a visited location register (VLR), which can reside in memory 530. Moreover, CS gateway node(s) 512 interfaces CS-based traffic and signaling and PS gateway node(s) 518. As an example, in a 3GPP UMTS network, CS gateway node(s) 512 can be realized at least in part in gateway GPRS support node(s) (GGSN). It should be appreciated that functionality and specific operation of CS gateway node(s) 512, PS gateway node(s) 518, and serving node(s) 516, is provided and dictated by radio technologies utilized by mobile network platform 510 for telecommunication over a radio access network 520 with other devices, such as a radiotelephone 575.

In addition to receiving and processing CS-switched traffic and signaling, PS gateway node(s) 518 can authorize and authenticate PS-based data sessions with served mobile devices. Data sessions can comprise traffic, or content(s), exchanged with networks external to the mobile network platform 510, like wide area network(s) (WANs) 550, enterprise network(s) 570, and service network(s) 580, which can be embodied in local area network(s) (LANs), can also be interfaced with mobile network platform 510 through PS gateway node(s) 518. It is to be noted that WANs 550 and enterprise network(s) 570 can embody, at least in part, a service network(s) like IP multimedia subsystem (IMS). Based on radio technology layer(s) available in technology resource(s) or radio access network 520, PS gateway node(s) 518 can generate packet data protocol contexts when a data session is established; other data structures that facilitate routing of packetized data also can be generated. To that end, in an aspect, PS gateway node(s) 518 can comprise a tunnel interface (e.g., tunnel termination gateway (TTG) in 3GPP UMTS network(s) (not shown)) which can facilitate packetized communication with disparate wireless network(s), such as Wi-Fi networks.

In embodiment 500, mobile network platform 510 also comprises serving node(s) 516 that, based upon available radio technology layer(s) within technology resource(s) in the radio access network 520, convey the various packetized flows of data streams received through PS gateway node(s) 518. It is to be noted that for technology resource(s) that rely primarily on CS communication, server node(s) can deliver traffic without reliance on PS gateway node(s) 518; for example, server node(s) can embody at least in part a mobile switching center. As an example, in a 3GPP UMTS network, serving node(s) 516 can be embodied in serving GPRS support node(s) (SGSN).

For radio technologies that exploit packetized communication, server(s) 514 in mobile network platform 510 can execute numerous applications that can generate multiple disparate packetized data streams or flows, and manage (e.g., schedule, queue, format . . . ) such flows. Such application(s) can comprise add-on features to standard services (for example, provisioning, billing, customer support . . . ) provided by mobile network platform 510. Data streams (e.g., content(s) that are part of a voice call or data session) can be conveyed to PS gateway node(s) 518 for authorization/authentication and initiation of a data session, and to serving node(s) 516 for communication thereafter. In addition to application server, server(s) 514 can comprise utility server(s), a utility server can comprise a provisioning server, an operations and maintenance server, a security server that can implement at least in part a certificate authority and firewalls as well as other security mechanisms, and the like. In an aspect, security server(s) secure communication served through mobile network platform 510 to ensure network's operation and data integrity in addition to authorization and authentication procedures that CS gateway node(s) 512 and PS gateway node(s) 518 can enact. Moreover, provisioning server(s) can provision services from external network(s) like networks operated by a disparate service provider; for instance, WAN 550 or Global Positioning System (GPS) network(s) (not shown). Provisioning server(s) can also provision coverage through networks associated to mobile network platform 510 (e.g., deployed and operated by the same service provider), such as the distributed antennas networks shown in FIG. 1(s) that enhance wireless service coverage by providing more network coverage.

It is to be noted that server(s) 514 can comprise one or more processors configured to confer at least in part the functionality of mobile network platform 510. To that end, the one or more processors can execute code instructions stored in memory 530, for example. It should be appreciated that server(s) 514 can comprise a content manager, which operates in substantially the same manner as described hereinbefore.

In example embodiment 500, memory 530 can store information related to operation of mobile network platform 510. Other operational information can comprise provisioning information of mobile devices served through mobile network platform 510, subscriber databases; application intelligence, pricing schemes, e.g., promotional rates, flat-rate programs, couponing campaigns; technical specification(s) consistent with telecommunication protocols for operation of disparate radio, or wireless, technology layers; and so forth. Memory 530 can also store information from at least one of telephony network(s) 540, WAN 550, SS7 network 560, or enterprise network(s) 570. In an aspect, memory 530 can be, for example, accessed as part of a data store component or as a remotely connected memory store.

In order to provide a context for the various aspects of the disclosed subject matter, FIG. 5, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules comprise routines, programs, components, data structures, etc. that perform particular tasks and/or implement particular abstract data types.

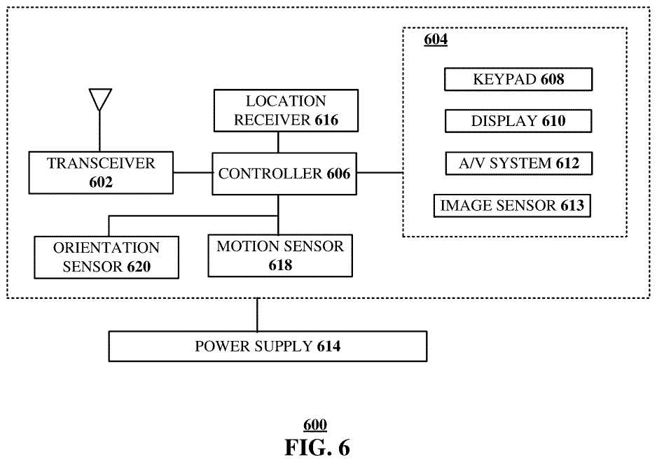

Turning now to FIG. 6, an illustrative embodiment of a communication device 600 is shown. The device 600 can serve as an illustrative embodiment of devices such as data terminals 114, mobile devices 124, vehicle 126, display devices 144 or other client devices for communication via either communications network 125. For example, communication device 600 can facilitate in whole or in part determining the intent of communications including voicemail, live calls, and text messages and identifying synthetic or cloned voice characteristics, and generating a threat level indicator for user awareness.

The communication device 600 can comprise a wireline and/or wireless transceiver 602 (herein transceiver 602), a user interface (UI) 604, a power supply 614, a location receiver 616, a motion sensor 618, an orientation sensor 620, and a controller 606 for managing operations thereof. The transceiver 602 can support short-range or long-range wireless access technologies such as Bluetooth®, ZigBee®, Wi-Fi, DECT, or cellular communication technologies, just to mention a few (Bluetooth® and ZigBee® are trademarks registered by the Bluetooth® Special Interest Group and the ZigBee® Alliance, respectively). Cellular technologies can include, for example, CDMA-1X, UMTS/HSDPA, GSM/GPRS, TDMA/EDGE, EV/DO, WiMAX, SDR, LTE, as well as other next generation wireless communication technologies as they arise. The transceiver 602 can also be adapted to support circuit-switched wireline access technologies (such as PSTN), packet-switched wireline access technologies (such as TCP/IP, VoIP, etc.), and combinations thereof.

The UI 604 can include a depressible or touch-sensitive keypad 608 with a navigation mechanism such as a roller ball, a joystick, a mouse, or a navigation disk for manipulating operations of the communication device 600. The keypad 608 can be an integral part of a housing assembly of the communication device 600 or an independent device operably coupled thereto by a tethered wireline interface (such as a USB cable) or a wireless interface supporting for example Bluetooth®. The keypad 608 can represent a numeric keypad commonly used by phones, and/or a QWERTY keypad with alphanumeric keys. The UI 604 can further include a display 610 such as monochrome or color LCD (Liquid Crystal Display), OLED (Organic Light Emitting Diode) or other suitable display technology for conveying images to an end user of the communication device 600. In an embodiment where the display 610 is touch-sensitive, a portion or all of the keypad 608 can be presented by way of the display 610 with navigation features.

The display 610 can use touch screen technology to also serve as a user interface for detecting user input. As a touch screen display, the communication device 600 can be adapted to present a user interface having graphical user interface (GUI) elements that can be selected by a user with a touch of a finger. The display 610 can be equipped with capacitive, resistive or other forms of sensing technology to detect how much surface area of a user's finger has been placed on a portion of the touch screen display. This sensing information can be used to control the manipulation of the GUI elements or other functions of the user interface. The display 610 can be an integral part of the housing assembly of the communication device 600 or an independent device communicatively coupled thereto by a tethered wireline interface (such as a cable) or a wireless interface.

The UI 604 can also include an audio system 612 that utilizes audio technology for conveying low volume audio (such as audio heard in proximity of a human ear) and high-volume audio (such as speakerphone for hands free operation). The audio system 612 can further include a microphone for receiving audible signals of an end user. The audio system 612 can also be used for voice recognition applications. The UI 604 can further include an image sensor 613 such as a charged coupled device (CCD) camera for capturing still or moving images.

The power supply 614 can utilize common power management technologies such as replaceable and rechargeable batteries, supply regulation technologies, and/or charging system technologies for supplying energy to the components of the communication device 600 to facilitate long-range or short-range portable communications. Alternatively, or in combination, the charging system can utilize external power sources such as DC power supplied over a physical interface such as a USB port or other suitable tethering technologies.

The location receiver 616 can utilize location technology such as a global positioning system (GPS) receiver capable of assisted GPS for identifying a location of the communication device 600 based on signals generated by a constellation of GPS satellites, which can be used for facilitating location services such as navigation. The motion sensor 618 can utilize motion sensing technology such as an accelerometer, a gyroscope, or other suitable motion sensing technology to detect motion of the communication device 600 in three-dimensional space. The orientation sensor 620 can utilize orientation sensing technology such as a magnetometer to detect the orientation of the communication device 600 (north, south, west, and east, as well as combined orientations in degrees, minutes, or other suitable orientation metrics).

The communication device 600 can use the transceiver 602 to also determine a proximity to a cellular, Wi-Fi, Bluetooth®, or other wireless access points by sensing techniques such as utilizing a received signal strength indicator (RSSI) and/or signal time of arrival (TOA) or time of flight (TOF) measurements. The controller 606 can utilize computing technologies such as a microprocessor, a digital signal processor (DSP), programmable gate arrays, application specific integrated circuits, and/or a video processor with associated storage memory such as Flash, ROM, RAM, SRAM, DRAM or other storage technologies for executing computer instructions, controlling, and processing data supplied by the aforementioned components of the communication device 600.

Other components not shown in FIG. 6 can be used in one or more embodiments of the subject disclosure. For instance, the communication device 600 can include a slot for adding or removing an identity module such as a Subscriber Identity Module (SIM) card or Universal Integrated Circuit Card (UICC). SIM or UICC cards can be used for identifying subscriber services, executing programs, storing subscriber data, and so on.

The terms “first,” “second,” “third,” and so forth, as used in the claims, unless otherwise clear by context, is for clarity only and does not otherwise indicate or imply any order in time. For instance, “a first determination,” “a second determination,” and “a third determination,” does not indicate or imply that the first determination is to be made before the second determination, or vice versa, etc.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can comprise both volatile and nonvolatile memory, by way of illustration, and not limitation, volatile memory, non-volatile memory, disk storage, and memory storage. Further, nonvolatile memory can be included in read only memory (ROM), programmable ROM (PROM), electrically programmable ROM (EPROM), electrically erasable ROM (EEPROM), or flash memory. Volatile memory can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that the disclosed subject matter can be practiced with other computer system configurations, comprising single-processor or multiprocessor computer systems, mini-computing devices, mainframe computers, as well as personal computers, hand-held computing devices (e.g., PDA, phone, smartphone, watch, tablet computers, netbook computers, etc.), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

In one or more embodiments, information regarding use of services can be generated including services being accessed, media consumption history, user preferences, and so forth. This information can be obtained by various methods including user input, detecting types of communications (e.g., video content vs. audio content), analysis of content streams, sampling, and so forth. The generating, obtaining and/or monitoring of this information can be responsive to an authorization provided by the user. In one or more embodiments, an analysis of data can be subject to authorization from user(s) associated with the data, such as an opt-in, an opt-out, acknowledgement requirements, notifications, selective authorization based on types of data, and so forth.

Some of the embodiments described herein can also employ artificial intelligence (AI) to facilitate automating one or more features described herein. The embodiments (e.g., in connection with automatically identifying acquired cell sites that provide a maximum value/benefit after addition to an existing communication network) can employ various AI-based schemes for carrying out various embodiments thereof. Moreover, the classifier can be employed to determine a ranking or priority of each cell site of the acquired network. A classifier is a function that maps an input attribute vector, x=(x₁, x₂, x₃, x₄ . . . xₙ), to a confidence that the input belongs to a class, that is, f(x)=confidence (class). Such classification can employ a probabilistic and/or statistical-based analysis (e.g., factoring into the analysis utilities and costs) to determine or infer an action that a user desires to be automatically performed. A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches comprise, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated, one or more of the embodiments can employ classifiers that are explicitly trained (e.g., via a generic training data) as well as implicitly trained (e.g., via observing UE behavior, operator preferences, historical information, receiving extrinsic information). For example, SVMs can be configured via a learning or training phase within a classifier constructor and feature selection module. Thus, the classifier(s) can be used to automatically learn and perform a number of functions, including but not limited to determining according to predetermined criteria which of the acquired cell sites will benefit a maximum number of subscribers and/or which of the acquired cell sites will add minimum value to the existing communication network coverage, etc.

As used in some contexts in this application, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or computer-readable storage/communications media. For example, computer readable storage media can include, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications that can be made to this configuration without departing from the scope or spirit of the various embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, the use of the word example or exemplary is intended to present concepts in a concrete fashion. As used in this application, the term “or” is intended to mean an inclusive “or” rather than an exclusive “or”. That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “user equipment,” “mobile station,” “mobile,” subscriber station,” “access terminal,” “terminal,” “handset,” “mobile device” (and/or terms representing similar terminology) can refer to a wireless device utilized by a subscriber or user of a wireless communication service to receive or convey data, control, voice, video, sound, gaming or substantially any data-stream or signaling-stream. The foregoing terms are utilized interchangeably herein and with reference to the related drawings.

Furthermore, the terms “user,” “subscriber,” “customer,” “consumer” and the like are employed interchangeably throughout, unless context warrants particular distinctions among the terms. It should be appreciated that such terms can refer to human entities or automated components supported through artificial intelligence (e.g., a capacity to make inference based, at least, on complex mathematical formalisms), which can provide simulated vision, sound recognition and so forth.

As employed herein, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Processors can exploit nano-scale architectures such as, but not limited to, molecular and quantum-dot based transistors, switches and gates, in order to optimize space usage or enhance performance of user equipment. A processor can also be implemented as a combination of computing processing units.

As used herein, terms such as “data storage,” data storage,” “database,” and substantially any other information storage component relevant to operation and functionality of a component, refer to “memory components,” or entities embodied in a “memory” or components comprising the memory. It will be appreciated that the memory components or computer-readable storage media, described herein can be either volatile memory or nonvolatile memory or can include both volatile and nonvolatile memory.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

What is claimed is:

1. A device, comprising:
a processing system including a processor; and
a memory that stores executable instructions that, when executed by the processing system, facilitate performance of operations, the operations comprising:
receiving a forwarded communication from a user device, wherein the forwarded communication is selected from an audio communication and a text communication;
responsive to receiving the text communication as the forwarded communication, analyzing the text communication to determine an intent of the forwarded communication;
responsive to receiving the text communication as the forwarded communication, determining whether the text communication contains artificial intelligence generation characteristics;
responsive to receiving the audio communication as the forwarded communication, analyzing audio features of the audio communication to determine if a voice of the forwarded communication is synthesized;
responsive to receiving the audio communication as the forwarded communication, determining whether the audio communication includes synthetic or cloned voice characteristics;
generating a threat level indicator based on the intent of the forwarded communication, a presence of artificial intelligence generation characteristics, and a presence of synthetic or cloned voice characteristics of the audio communication; and
providing the threat level indicator to the user device.

2. The device of claim 1, wherein the receiving the forwarded communication comprises:
receiving a voicemail message or an active call audio segment received at the user device as the audio communication.

3. The device of claim 1, wherein the operations further comprise:
receiving a bridge of an active call between the user device and a network server;
receiving an active call audio segment of the active call at the network server;
analyzing an audio signature of the active call audio segment to determine the intent of the active call audio segment;
analyzing the audio signature of the active call audio segment to identify synthetic or cloned voice characteristics of the active call audio segment; and
providing, to the user device, a live indication of the threat level indicator, substantially in real time during the active call.

4. The device of claim 3, wherein the receiving the bridge of an active call between the user device and a network server is responsive to a user actuation of a user interface of the user device and wherein the operations further comprise:
receiving full call audio of the active call at the network server following the bridge of the active call between the user device and the network server.

5. The device of claim 1, wherein the operations further comprise:
receiving the forwarded communication from the user device at an application programming interface (API) of a network server, including
receiving text corresponding to a short message service (SMS) text message communicated to the user device on a mobile communication network; or
receiving text corresponding to an over-the-top text message communicated to an application operating on the user device over a communication network.

6. The device of claim 1, wherein the operations further comprise:
receiving, from the user device, data corresponding to a screenshot image of a text conversation displayed on a display screen of the user device; and
using visual processing, extracting text of the screenshot image, forming the text communication.

7. The device of claim 1, wherein the operations further comprise:
receiving data of a voicemail message from the user device at a network server;
transcribing the data of a voicemail message into transcribed text; and
analyzing the transcribed text to determine the intent of the voicemail message and a likelihood of a synthetic or cloned voice in the voicemail message.

8. The device of claim 1, wherein the operations further comprise:
transcribing the audio communication into transcribed text; and
analyzing the transcribed text to determine the intent of the forwarded communication.

9. The device of claim 8, wherein the operations further comprise:
analyzing the audio features of the audio communication using an ensemble of models to identify synthetic or cloned voice characteristics in the audio communication.

10. The device of claim 9, wherein the analyzing the audio features of the audio communication using an ensemble of models comprises:
analyzing the audio features of the audio communication with at least one convolutional neural network module and one generative artificial intelligence module.

11. A non-transitory machine-readable medium, comprising executable instructions that, when executed by a processing system including a processor, facilitate performance of operations, the operations comprising:
receiving, via an application programming interface, a communication content forwarded from a mobile device, wherein the communication content is selected from the group consisting of a voicemail message, an active call audio segment, and a text message;
analyzing the communication content, wherein the analyzing comprises analyzing the communication content with artificial intelligence (AI) models and audio signal processing to determine an intent of the communication content and a probability that the communication content is AI generated, synthetic, or cloned;
generating a threat indication based on the intent of the communication content and a probability that the communication content is AI generated, synthetic, or cloned; and
transmitting the threat indication to the mobile device for display to a subscriber.

12. The non-transitory machine-readable medium of claim 11, wherein the analyzing the communication content comprises:
analyzing audio features of the communication content using an ensemble of models to identify synthetic or cloned voice characteristics in the communication content.

13. The non-transitory machine-readable medium of claim 12, wherein the analyzing the communication content comprises:
analyzing the communication content using a convolutional neural network for detecting synthetic voice characteristics of the communication content.

14. The non-transitory machine-readable medium of claim 11, wherein the operations further comprise:
transcribing the voicemail message or the active call audio segment into transcribed text; and
analyzing the transcribed text to determine the intent of the communication content.

15. The non-transitory machine-readable medium of claim 11, wherein the operations further comprise:
generating the threat indication when the probability that the communication content is AI generated, synthetic, or cloned exceeds a threshold value of 75%; and
transmitting the threat indication via push notification to the mobile device.

16. A method,
comprising:
receiving, by a processing system including a processor of a network server in a communications network, a forwarded communication from a user device active on the communication network, wherein the forwarded communication is selected from an audio communication and a text communication;
analyzing, by the processing system, the forwarded communication to determine an intent of the forwarded communication, wherein the analyzing, when applied to the text communication, comprises determining whether the text communication contains artificial intelligence generation characteristics, and wherein the analyzing, when applied to the audio communication, comprises both analyzing audio features to determine an intent of the audio communication and determining whether the audio communication includes synthetic voice characteristics or cloned voice characteristics;
generating, by the processing system, a threat level indicator based on the intent of the forwarded communication and a presence of the artificial intelligence generation characteristics or the synthetic voice characteristics or cloned voice characteristics; and
providing, by the processing system, the threat level indicator to the user device.

17. The method of claim 16, wherein the analyzing the forwarded communication comprises:
analyzing, by the processing system, the forwarded communication utilizing artificial intelligence (AI) models, including a deep learning algorithm, to enhance an accuracy of intent determination and detection of AI characteristics.

18. The method of claim 16, wherein the analyzing the forwarded communication comprises:
analyzing, by the processing system, text communications utilizing natural language processing (NLP) to improve determination of intent.

19. The method of claim 16, wherein the analyzing the forwarded communication comprises:
analyzing, by the processing system, contextual information, including ender identity information and historical communication patterns, to enhance accuracy of determination of intent.

20. The method of claim 16, wherein the providing the threat level indicator to the user device comprises:
providing, by the processing system, the threat level indicator having different levels related to a perceived level of severity of a threat associated with the forwarded communication from the user device.
